(19) United States
(12) Patent Application Publication
(10) Pub. No.: US 2018/0060568 A1
(43) Pub. Date: Mar. 1, 2018

(54) System And Method Of Dynamically Updating Stack Canaries

(71) Applicant: QUALCOMM Incorporated, San Diego, CA (US)

(72) Inventors: Joel Galenson, Santa Clara, CA (US); Sudha Anil Kumar Gathala, Tracy, CA (US); Minjang Kim, San Jose, CA (US)

(21) Appl. No.: 15/244,080

(22) Filed: Aug. 23, 2016

(51) Int. Cl. G06F 21/54; G06F 21/55

(52) U.S. Cl. CPC G06F 21/54; G06F 2221/034; G06F 21/554

(57) ABSTRACT

Various embodiments enhance protections against stack buffer overflow attacks in a computing device by dynamically updating stack canaries. Canary values on the stack of a child process may be replaced with new canary values in response to determining that a condition for generating new canary values is satisfied. Canary values on the stack of a child process may be replaced with new canary values when a child process is forked following a crash of a previous child process of the parent process. Canary values on the stack of a child process may be replaced with new canary values in response to expiration of a canary timeout time. The locations of the canaries to replace may be determined by walking the stack to locate entries in each stack frame that match a previous value of the canary or by walking the stack according to a predefined stack frame format.

### BACKGROUND

Control hijacking software typically takes control of a service or an application (hereinafter “program”) on a server or other computing device to execute malicious code. For example, an attacker may attempt to execute malicious code that obtains a shell through which to steal private data. Control hijacking attacks may use stack buffer overflows to take control of the program.

Stack smashing is a form of stack buffer overflow attack in which an attacker overflows a buffer on a stack in memory and overwrites the saved return address (or other code pointer) on the stack so that the program jumps to the address of an attacker-controlled location in the program's address space. Alternatively, with return-oriented programming (ROP) attacks, the original return address is overwritten with a sequence of code pointers that link together short code blocks already present in the program's address space in order to gain control of the program. In another example, return-to-libc attacks overwrite the return address on the stack with a code pointer to a high-level library function (e.g., system( ) function) that provides an attacker with access to the kernel services (e.g., shell).

### SUMMARY

Various embodiments are disclosed for enhancing protections against stack buffer overflow attacks in a computing device by dynamically updating stack canaries. Various embodiments may be particularly useful for preventing an attacker from taking control of a program by stack smashing. In some embodiments, dynamically updating stack canaries may include a processor determining whether a condition for generating new canary values is satisfied, generating one or more new canary values in response to determining that the condition for generating new canary values is satisfied, locating one or more canaries on a stack, and replacing one or more previous canary values of the one or more canaries on the stack with the one or more new canary values.

In some embodiments, determining whether the condition for generating the new canary values is satisfied may be performed by the processor in response to forking a child process from a parent process in a memory, such that the child process includes the stack including the one or more canaries. In some embodiments, determining whether the condition for generating the new canary values is satisfied may include the processor determining whether a child process was forked following a crash of one or more previous child processes and generating the one or more new canary values in response to determining that the child process was forked following a crash of the one or more previous child processes.

In some embodiments, determining whether the condition for generating the new canary values is satisfied may include the processor determining whether a canary timeout time has elapsed and generating the one or more new canary values in response to determining that the canary timeout time has elapsed.

In some embodiments, locating the one or more canaries on the stack may include the processor obtaining a previous canary value, locating one or more stack frames on the stack, comparing the previous canary value to data entries in the one or more stack frames, and locating the one or more canaries on the stack at one or more locations corresponding to one or more of the data entries that match the previous canary value.

In some embodiments, locating the one or more canaries on the stack may include locating one or more stack frames on the stack and locating a canary in the one or more stack frames based on a predefined stack frame format. In some embodiments, locating a canary in the one or more stack frames based on the predefined stack frame format may include the processor locating a stack frame pointer in a stack frame and locating the canary in the stack frame at an offset relative to the stack frame pointer located in the stack frame, such that offset is predefined in the predefined stack frame format.

In some embodiments, the child process may include multiple stacks to manage multiple processing threads, and the method may further include the processor generating multiple new canary values in response to determining that the condition is satisfied, such that each of the new canary values corresponds to one of the multiple processing threads, locating the one or more canaries on each of the plurality of stacks, and replacing the one or more canaries on each of the multiple stacks with the new canary values generated for that a corresponding one of processing threads.

In some embodiments, locating the one or more canaries on the stack may include the processor locating one or more stack frames on the stack, determining for each of the one or more stack frames whether the stack frame is associated with a no-return function attribute, and locating a canary in the stack frame in response to determining that the stack frame is not associated with a no-return function attribute. In some embodiments, locating the one or more canaries on the stack may further include the processor skipping the stack frame in response to determining that the stack frame is associated with a no-return function attribute.

Further embodiments may include a computing device including a processor configured with processor-executable instructions to perform operations of the embodiment methods summarized above. Further embodiments include a non-transitory processor-readable storage medium having stored thereon processor-executable instructions configured to cause a processor to perform operations of the embodiment methods summarized above. Further embodiments include a computing device including means for performing functions of the embodiment methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a schematic diagram of a stack that includes canaries (i.e., random values) to provide canary-protected stack frames.

FIG. 2 is a process flow diagram illustrating a method of dynamically updating stack canaries according to some embodiments.

FIG. 3 is a process flow diagram illustrating another method of dynamically updating stack canaries according to some embodiments.

FIG. 4 is a process flow diagram illustrating another method of dynamically updating stack canaries according to some embodiments.

FIG. 5 is a schematic diagram illustrating components of a server that may be configured to implement methods according to some embodiments.

FIG. 6 is a schematic diagram illustrating components of a smartphone type mobile communication device that may be configured to implement methods according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide methods implemented in computing devices for enhancing protections against stack buffer overflow attacks by dynamically updating stack canaries.

The term “computing device” is used herein to refer to an electronic device equipped with at least a processor. Examples of computing devices may include, but not limited to, mobile communication devices (e.g., cellular telephones, wearable devices, smart-phones, web-pads, tablet computers, Internet enabled cellular telephones, Wi-Fi® enabled electronic devices, personal data assistants (PDA's), etc.), personal computers (e.g., laptop computers, etc.), and servers.

The term “process” is used herein to refer to an instance of a computer program executing in memory. A process may include executable program code and data structures for storing information regarding the execution state of the program (e.g., a stack). In some embodiments, a process may include multiple threads. Each thread may include executable program code and a stack specific to that thread in memory.

The term “stack” is used herein to refer to a data structure maintained in a process that stores information about active functions (e.g., subroutines) for a specific instance of a computer program. A stack frame may be added, or pushed, onto the stack for each function that is called within the executable program code. The stack frame of a called function may include a stack frame pointer, return address, canary, and one or more data buffers. The stack frame of the called function may be removed, or popped, from the stack in response to the called function completing execution.

The term “fork” is used herein to refer to an operation whereby a process creates a copy of itself, the copy including the process's stack and other resources of resources. The process that creates the copy is sometimes referred to as a “parent process” and the copy of the parent process is sometimes referred to as a “child process.” A fork operation may be initiated by the parent process invoking a fork system call of the operating system.

The term “canary” is used herein to refer to a random value that is placed on the stack to monitor buffer overflows. When a buffer overflow occurs, the canary may be overwritten and thus corrupted. Stack buffer overflows may be detected by comparing the current value of the canary with a known value of the canary placed on the stack. For example, when the current value of the canary does not match the known value of the canary, a stack buffer overflow may be detected.

When a program is initially launched, a process (referred to herein as the “parent process”) may be instantiated in memory that forks a child process to execute an instance of the program. When the child process crashes (e.g., terminates abnormally), the parent process may restart the program by forking another child process to execute another instance of the program, which includes a copy of the resources of the parent process. The resource of the parent process may include a copy of the parent's stack.

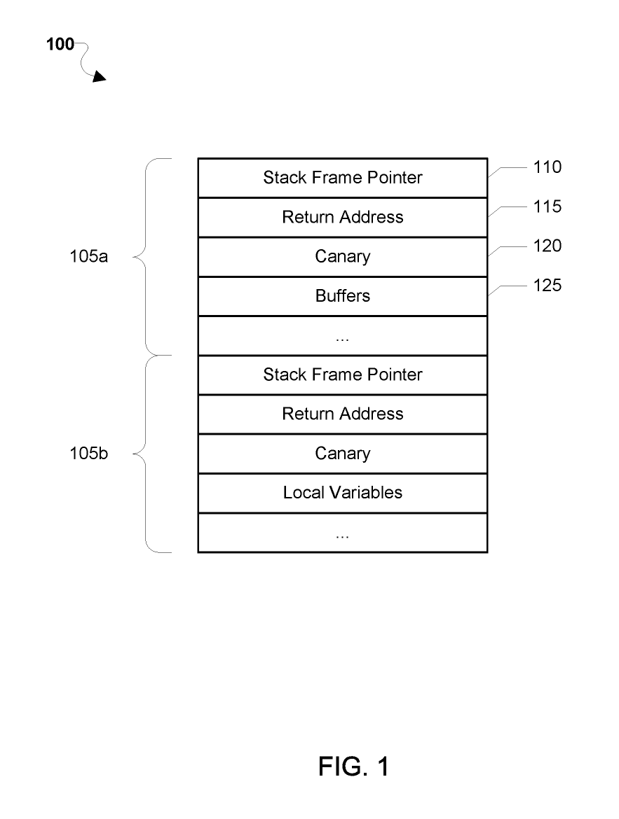

To defend against stack buffer overflows, a stack may be augmented with random values referred to as “canaries” to detect overwrites on the stack. For example, FIG. 1 is a schematic diagram of a stack 100 that includes canaries 120 (i.e., random values) to provide canary-protected stack frames 105a and 105b. The canary 120 may be inserted at a predefined location of a function's stack frame (e.g. after the stack frame pointer 110 between the buffers 125 and the return address 115). Alternatively, the canary 120 may be inserted at different locations in each function stack frame. Thus, when the child process crashes, the parent process may restart the program by forking another child process, such that the stack of child process includes the canaries of the parent process. If the canary value is static (i.e., does not change), an attacker can discover the fixed-value canary through brute-force techniques in which the attacker guesses and overwrites a single byte of the canary on the stack until the program fails to crash. This technique may be repeated for each byte of the canary until every byte of the canary is determined.

When a function returns and prior to the function's stack frame being removed from the stack 100, the value of the canary 120 is read from the stack frame and checked against a saved value of the canary in the kernel. For example, if an attacker causes a stack buffer overflow and the return address 115 is overwritten, the canary 120 on the stack frame will also be overwritten. Thus, unless the attacker knows the saved value of the canary and its location on the stack, the canary 120 will be overwritten with the wrong value and the attack will be detected. For example, an error may be generated and/or the program may crash.

In order to prevent an attacker from discovering a canary value using brute-force techniques, some prior computing devices may replace the canaries on the stack with a new randomized canary value every time a child process is forked. Further, in order to locate the canaries on the stack, some prior computing devices may maintain a separate data structure, such as an address stack, that stores pointers (e.g., memory addresses) to the canaries on the stack. Thus, whenever a child process is forked, a copy of the address stack is provided in the memory space of the child process for use in locating the canaries to replace on the stack. Such techniques impose extra overhead and processing costs on every function call and return.

Various embodiments are disclosed for dynamically updating canaries on a stack. Various embodiments may be particularly useful for preventing an attacker from taking control of a program by stack smashing, such that the extra overhead and/or processing costs associated with prior techniques may be avoided. In some embodiments, for example, canary values on the stack of a child process may be replaced with new canary values in response to determining that a condition for generating new canary values is satisfied. For example, in some embodiments, canary values on the stack of a child process may be replaced with new canary values in response to determining that a child process is forked following a crash of one or more previous child processes of the parent process. In some embodiments, the canary values on the stack of a child process may be replaced with new canary values in response to expiration of a canary timeout. In some embodiments, the canary values on the stack of a child process may be replaced with new canary values based on configuration parameters and/or profile information associated with individual or classes of programs or executable binaries. In some embodiments, the locations of the canaries to replace may be determined by walking the stack to locate entries in each stack frame that match a previous value of the canary. In some embodiments, the locations of the canaries to replace may be determined by walking the stack according to a predefined stack frame format.

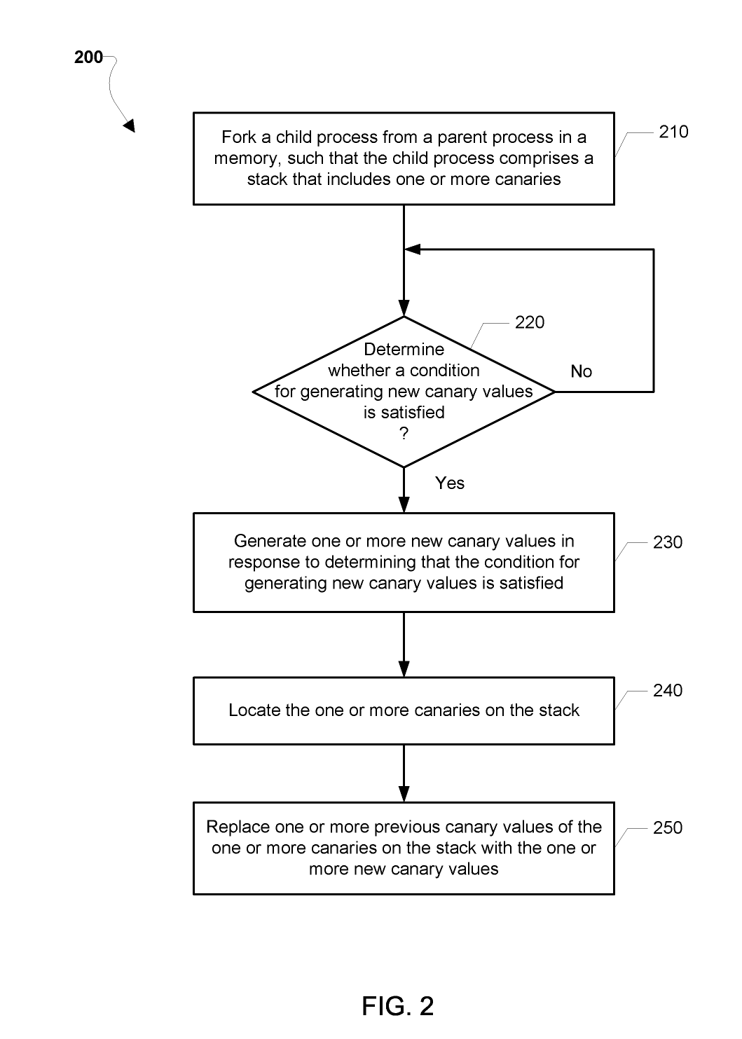

FIG. 2 is a flow diagram illustrating a method 200 of dynamically updating canaries on a stack according to some embodiments. With reference to FIGS. 1-2, operations of the method 200 may be performed by a processor of a computing device.

In block 210, a processor may fork a child process from a parent process in a memory, such that the child process includes a stack (e.g., 100 of FIG. 1) that includes one or more canaries (e.g., 120 of FIG. 1). In some embodiments, the processor may fork the child process by executing a fork( ) system call that may be defined in a memory space of a kernel or operating system (referred to herein as the “kernel memory space”). In response to execution of the fork( ) system call, the child process may be defined in a user or application memory space (referred to herein as the “user memory space”) containing a copy of the resources of the parent process, including the stack (e.g., 100). Each of the one or more canaries (e.g., 120) included in the stack of the child process may contain a previous canary value used in the parent process. In some embodiments, the child process may include multiple stacks to manage multiple processing threads. For example, each of the multiple stacks included in the child process may correspond to one of multiple processing threads previously defined in a multi-threaded parent process.

In determination block 220, the processor may determine whether a condition for generating new canary values is satisfied. In some embodiments, determining whether the condition is satisfied may be based on a configuration parameter or profile information stored in memory for individual or classes of programs or executable binaries. For example, a table of configuration parameters may specifically identify individual or classes of programs or binaries for which new canary values may be generated (e.g., config_rand_canary_always[“name of binary”]). In another example, security profile information may be used to determine which programs or executable binaries may be vulnerable to control hijacking or other malicious attacks on the stack, and thus may benefit from new canary values being generated. For example, in some embodiments, the security profile information may be provided by a security monitoring application or service that identifies or marks one or more programs as suspicious.

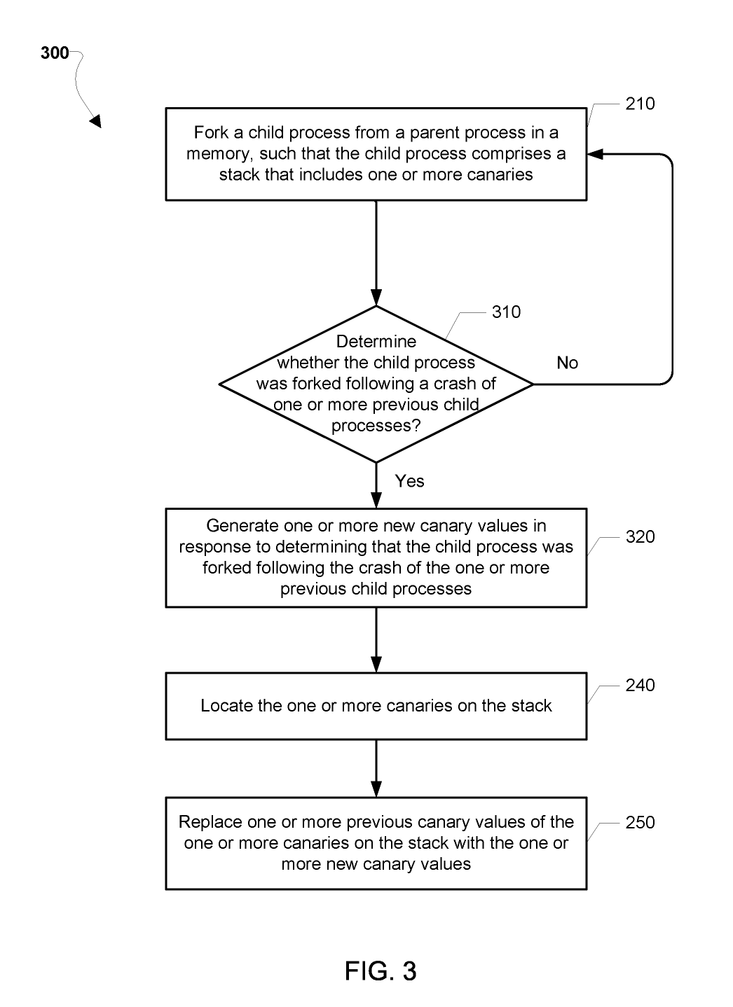

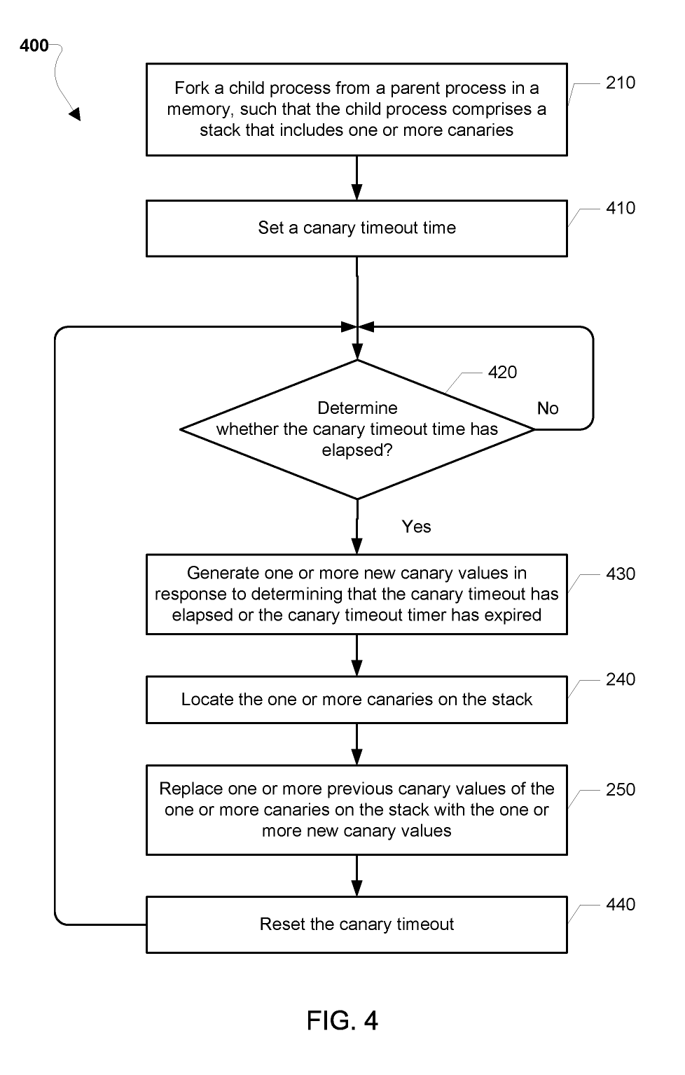

In some embodiments, determining whether the condition is satisfied may be based on information indicating whether the child process was forked following a crash of one or more child processes (i.e., the fork was initiated because of a prior crash of a child process). In some embodiments, determining whether the condition is satisfied may be based on information indicating whether a canary timeout has elapsed. Examples of such embodiments are described and illustrated in more detail with reference to FIGS. 3 and 4. Thus, various embodiments may reduce the amount of overhead and processing costs associated with replacing canaries on a stack by setting one or more conditions for determining when or if such updates of stack canaries should be carried out.

In response to determining that the condition for generating new canary values is not satisfied (i.e., determination block 220=“No”), the processor may continue to determine whether a condition for generating a new canary value is satisfied by repeating the operations in determination block 220.

In response to determining that the condition for generating new canary values is satisfied (i.e., determination block 220=“Yes”), the processor may generate one or more new canary values in block 230. In some embodiments, the new canary value for the child process may be stored in a defined portion of the kernel memory space.

In implementations in which the forked child process includes multiple stacks to manage multiple processing threads, the processor may generate multiple new canary values in block 230 when the condition is satisfied (i.e., determination block 220=“Yes”). For example, a new canary value may be generated for each stack, such that the canaries on each stack may be replaced with a new canary value unique to that stack. By generating a unique canary value for each of the multiple stacks, an attacker may be thwarted from determining the value of the canaries on the stack of one of the processing threads and using the same canary values to overwrite the canary values on another processing thread stack.

In block 240, the processor may locate the one or more canaries (e.g., 120) on the stack (e.g., 100). In some embodiments, for example, the processor may locate the one or more canaries on the stack by locating one or more stack frames (e.g., 105a, 105b) on the stack and locating a canary in each of the one or more stack frames based on a predefined stack frame format. The predefined stack frame format may be, or be derived from, an application binary interface (ABI) of a compiler. In some embodiments, the predefined stack frame format may specify the location of a canary (e.g., 120) within a stack frame at an offset relative to the stack frame pointer (e.g., 110) of the stack frame.

In some embodiments, the processor may locate the one or more canaries on a stack in block 240 by obtaining the previous canary value used in the parent process, locating one or more stack frames (e.g., 105a, 105b) on the stack, comparing the previous canary value to data entries in each of the one or more stack frames, and locating the one or more canaries on the stack at one or more locations corresponding to one or more of the data entries that match the previous canary value.

In some embodiments, in block 240 the processor may attempt to locate the one or more canaries only in stack frames that are associated with functions having a no-return attribute. For example, in some embodiments, the processor may locate one or more stack frames on the stack, determine for each of the one or more stack frames whether the stack frame is associated with a no-return function attribute, and locate a canary in the stack frame in response to determining that the stack frame is not associated with a no-return function attribute. In response to determining that the stack frame is associated with a no-return function attribute, the processor may skip the stack frame and not attempt to locate a canary in that stack frame.

In some embodiments, in block 240 the processor may locate the one or more canary-protected stack frames (e.g., 105a, 105b) on each stack frame (e.g., 100) by walking the stack. For example, in some embodiments, walking the stack to locate stack frame pointers may be performed using an application programming interface (API), such as the libunwind API of the Savannah Non-GNU project which may programmatically unwind a stack to determine the call-chain of a program. For example, in some embodiments that use the libunwind API, the processor may call the function unw_step( ) in a loop to obtain a stack frame pointer (e.g., 110) for each stack frame (e.g., 105a, 105b). A positive return value from unw_step( ) indicates that there are more stack frames in the chain, zero indicates that the end of the chain has been reached, and any negative value indicates that an error occurred. Each stack frame may be bounded by the stack frame pointers of consecutive stack frames.

In some embodiments, the processor (e.g., an Advanced RISC Machines (ARM) processor) may locate the stack frame pointers of consecutive stack frames by referencing one or more registers that contain addresses to each stack frame pointer on a stack.

In block 250, the processor may replace the one or more previous canary values of the one or more canaries on the stack with the one or more new canary values. In some embodiments, the processor may access each location of the one or more canaries value as determined in block 240 and overwrite the previous canary value at that location with the new canary value. In implementations in which the forked child process includes multiple stacks to manage multiple processing threads, the previous values of the one or more canaries on each stack may be overwritten with a new canary value uniquely generated for that stack.

FIG. 3 is a process flow diagram that illustrates another method 300 of dynamically updating stack canaries according to some embodiments. As discussed above, when a child process corresponding to an instance of a program crashes, the parent process may restart the program by forking another child process, such that the stack of child process includes the canaries of the parent process. To defeat attempts by an attacker to discover canary values through brute-force techniques, the method 300 replaces canary values whenever a child process is forked in response to a previous child process crashing, as would happen in a brute force attack. In some embodiments, the method 300 may include determining whether a child process was forked following a crash of one or more previous child processes. Thus, when a child process is forked following a crash of a previous child process of the parent, a new canary value/values is/are generated and the previous canary value or values on the stack is/are replaced. Such embodiments may be useful in preventing brute force attacks that involve discovering the canary value and the attacker performing a stack buffer overflow attack that overwrites the canaries on the stack with the discovered canary value.

Operations of the method 300 may be performed by a processor of a computing device. In some embodiments, the operations of the method 300 may be performed by the processor of the computing device executing a modified fork( ) system call that may be called by a parent process of a program or other binary executable in memory. The method 300 includes operations in blocks 210, 240, and 250 described for like numbered blocks with reference to FIG. 2.

In determination block 310, the processor may determine whether the child process is forked following a crash (e.g., abnormal termination) of one or more previous child processes forked by the parent process. For example, the processor may determine whether the child process was forked immediately following a crash of a previous child process of the parent process. In another example, the processor may determine whether the child process was forked following a crash of a threshold number of multiple previous child processes.

In determination block 310, the processor may determine whether the child process is forked following a crash of one or more previous child processes based on exit codes returned by any of the previous child processes upon exit from memory. In some embodiments, a child process may exit memory upon the processor executing an exit( ) system call made by that process. For example, the exit( ) system call may return a zero (0) exit code for child processes that terminate normally and a non-zero exit code for child processes that terminate abnormally (e.g., crash). In some embodiments, the exit( ) system call of the operating system may be modified to store the exit code and other saved state information in a defined portion of the kernel memory space in response to a crash of a child process. In some embodiments, the parent process may track information corresponding to the crashed child processes (e.g., date and time stamp of last crash, number of recent crashes, etc.). Other techniques for determining whether one or more previous child process has crashed may also be used.

In response to determining that the child process is/was not forked following a crash of one or more previous child processes of the parent process (i.e., determination block 310=“No”), the processor may wait for the need to fork another child process in block 210.

In response to determining that the child process is/was forked following a crash of one or more child processes of the parent process (i.e., determination block 310=“Yes”), the processor may generate one or more new canary values in block 320.

For example, in some embodiments, the processor may randomly generate a new canary value for the child process. In implementations in which the forked child process includes multiple stacks to manage multiple processing threads, the processor may randomly generate multiple new canary values. For example, a new random canary value may be generated for each stack, thereby enabling the canaries on each stack to be replaced with a new canary value unique to that stack. Generating a unique canary value for each of the multiple stacks may thwart attacker attempting to determine the value of a canary on one stack of one processing thread and use the same canary value to overwrite the canary on another processing thread stack. In some embodiments, the fork( ) system call may store the generated new canary value for each child process in a defined portion of the kernel memory space.

FIG. 4 is a process flow diagram that illustrates another method 400 of dynamically updating stack canaries according to some embodiments. For example, the method 400 may include setting a canary timeout at which time the canaries on the one or more stacks of the child process may be replaced with new canary values. Thus, when the canary timeout elapses, a new canary value is generated and the previous canary value on the stack is replaced. Such embodiments may be useful in preventing brute force attacks that cause exception faults, but do not crash the parent process. Such embodiments may also be useful to improve security when there is a significant time lag between the attacker discovering the canary value and the attacker performing a stack buffer overflow attack that overwrites the canaries on the stack with the discovered canary value. Operations of the method 400 may be performed by a processor of a computing device. The method 400 may include operations in blocks 210, 240, and 250 as described for like numbered blocks with reference to FIG. 2.

In block 410, the processor may set a canary timeout time or start a canary timeout timer. For example, the processor may execute a process scheduler that manages the execution of processes in the user memory space. In some embodiments, the process scheduler may be modified to start a timer set with a timeout (e.g., 10 minutes, one hour, etc.) at which time the canaries on the one or more stacks of the child process may be replaced with new canary values (i.e., “canary timeout”).

In determination block 420, the processor may determine whether the canary timeout time has elapsed or a canary timeout timer has expired. In some embodiments, the process scheduler, executed by the processor, may determine that canary timeout time has elapsed or a canary timeout timer has expired in response to receiving an alert or interrupt from the canary timeout timer indicating that the timer has expired. The method may continue to block 430. So long as the canary timeout time has not elapsed or the canary timeout timer has not expired (i.e., determination block 420=“No”), the processor may continue to monitor the canary timeout time or timer in determination block 420.

In response to determining that the canary timeout time has elapsed or the canary timeout timer has expired (i.e., determination block 420=“Yes), the processor may generate a new canary value in block 430. In some embodiments, in response to determining that the canary timeout time has elapsed or the canary timeout timer has expired, the process scheduler, executed by the processor, may pause execution of the child process in order to generate new random canary value(s) and to replace the canary/canaries on the stack(s) for the child process (e.g., in block 250). In some embodiments, the process scheduler may store the new canary value for the child process in a defined portion of the kernel memory space.

In implementations in which the forked child process includes multiple stacks to manage multiple processing threads, the process scheduler may generate multiple new canary values in response to determining that the canary timeout time has elapsed. For example, a new canary value may be generated for each stack, such that the canaries on each stack may be replaced with a new canary value unique to that stack (e.g., in block 250).

In block 440, a process scheduler, executed by the processor, may reset the canary timeout time or canary timeout timer. In some embodiments, the process scheduler may reset the canary timeout time/timer after replacing the previous canary value of the one or more canaries on the stack with the new canary value in block 250. In some embodiments, the canary timeout time/timer may be reset to the same timeout value that was set in block 410. In some embodiments, the canary timeout time/timer may be reset to a timeout duration that is different from the canary timeout time/timer set in block 410.

After resetting the canary timeout time/timer in block 440, the process scheduler may repeat the operations in determination block 420 to again wait for the canary timeout time/timer to elapse/expire.

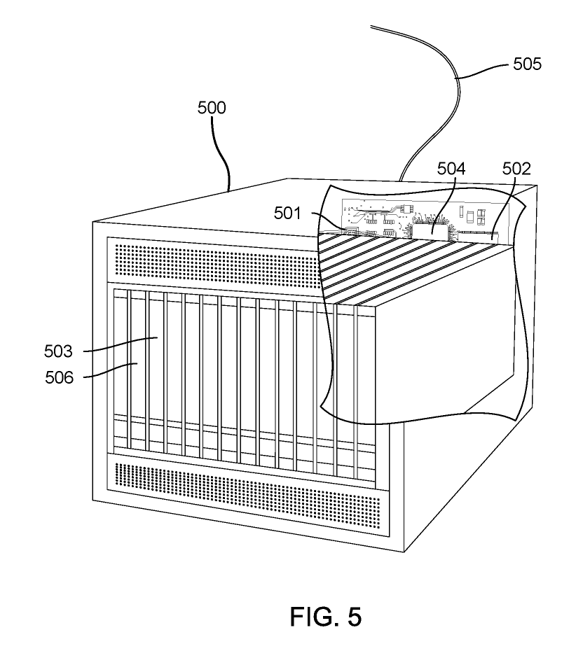

The various embodiments may be implemented on any of a variety of commercially available computing devices. For example, FIG. 5 is a schematic diagram illustrating components of a server 500 that may be configured to implement methods according to some embodiments, including the embodiments of the methods 200, 300 and 400 described with reference to FIGS. 2-4. Such a server 500 typically includes a processor 501 coupled to volatile memory 502 and a large capacity nonvolatile memory, such as a disk drive 503. The server 500 may also include a floppy disc drive, compact disc (CD) or DVD disc drive 506 coupled to the processor 501. The server 500 may also include network access ports 504 coupled to the processor 501 for establishing data connections with a network 505, such as a local area network coupled to other broadcast system computers and servers.

The processor 501 may be any programmable microprocessor, microcomputer or multiple processor chip or chips that can be configured by software instructions (applications) to perform a variety of functions, including the functions of the various embodiments described above. In some embodiments, multiple processors may be provided, such as one processor dedicated to wireless communication functions and one processor dedicated to running other applications. Typically, software applications may be stored in the internal memory 502, 503 before they are accessed and loaded into the processor 501. The processor 501 may include internal memory sufficient to store the application software instructions.

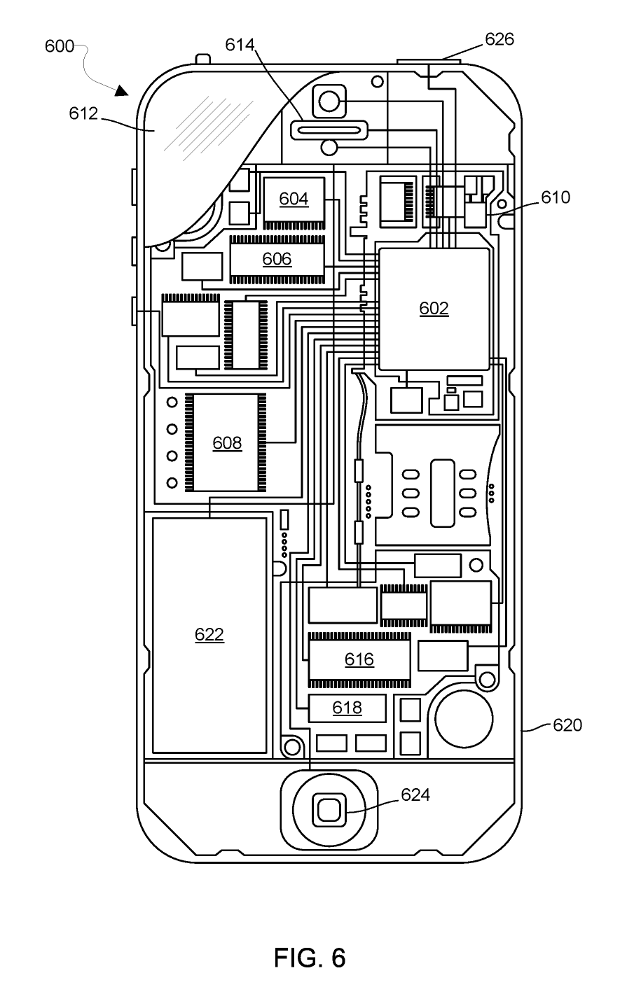

FIG. 6 is a system block diagram of a smartphone type mobile communication device 600 that may be configured to implement methods according to some embodiments, including the embodiments of the methods 200, 300 and 400 described with reference to FIGS. 2-4. A mobile communication device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the communication device 600 need not have touch screen capability. Additionally, the mobile communication device 600 may include a cellular network transceiver 608 coupled to the processor 602 and to an antenna 614 for sending and receiving electromagnetic radiation that may be connected to a wireless data link. The transceiver 608 and the antenna 610 may be used with the above-mentioned circuitry to implement various embodiment methods.

The mobile communication device 600 may have a cellular network transceiver 608 coupled to the processor 602 and to an antenna 610 and configured for sending and receiving cellular communications. The mobile communication device 600 may include one or more SIM cards 616, 618 coupled to the transceiver 608 and/or the processor 602 and may be configured as described above.

The mobile communication device 600 may also include speakers 614 for providing audio outputs. The mobile communication device 600 may also include a housing 620, constructed of a plastic, metal, or a combination of materials, for containing all or some of the components discussed herein. The mobile communication device 600 may include a power source 622 coupled to the processor 602, such as a disposable or rechargeable battery. The rechargeable battery may also be coupled to the peripheral device connection port to receive a charging current from a source external to the communication device 600. The communication device 600 may also include a physical button 624 for receiving user inputs. The mobile communication device 600 may also include a power button 626 for turning the mobile communication device 600 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a two or more microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of dynamically updating stack canaries, comprising:
determining, by a processor, whether a condition for generating new canary values is satisfied;
generating, by the processor, one or more new canary values in response to determining that the condition for generating new canary values is satisfied;
locating, by the processor, one or more canaries on a stack; and
replacing, by the processor, one or more previous canary values of the one or more canaries on the stack with the one or more new canary values.

2. The method of claim 1, wherein determining whether the condition for generating the new canary values is satisfied is performed by the processor in response to forking a child process from a parent process in a memory, wherein the child process comprises the stack that includes the one or more canaries.

3. The method of claim 2, wherein the child process comprises a plurality of stacks to manage a plurality of processing threads, wherein the method further comprises:
generating, by the processor, a plurality of new canary values in response to determining that the condition is satisfied, wherein each of the plurality of new canary values corresponds to one of the plurality of processing threads;
locating, by the processor, the one or more canaries on each of the plurality of stacks; and
replacing, by the processor, the one or more canaries on each of the plurality of stacks with the new canary values generated for the corresponding one of the plurality of processing threads.

4. The method of claim 1, wherein:
determining whether the condition for generating the new canary values is satisfied comprises determining, by the processor, whether a child process was forked following a crash of one or more previous child processes; and
generating the one or more new canary values in response to determining that the condition for generating the new canary values is satisfied comprises generating, by the processor, the one or more new canary values in response to determining that the child process was forked following a crash of the one or more previous child processes.

5. The method of claim 1, wherein:
determining whether the condition for generating the new canary values is satisfied comprises determining, by the processor, whether a canary timeout time has elapsed; and
generating the one or more new canary values in response to determining that the condition for generating the new canary values is satisfied comprises generating, by the processor, the one or more new canary values in response to determining that the canary timeout time has elapsed.

6. The method of claim 1, wherein locating the one or more canaries on the stack comprises:
obtaining, by the processor, a previous canary value;
locating, by the processor, one or more stack frames on the stack;
comparing, by the processor, the previous canary value to data entries in the one or more stack frames; and
locating, by the processor, the one or more canaries on the stack at one or more locations corresponding to one or more of the data entries that match the previous canary value.

7. The method of claim 1, wherein locating the one or more canaries on the stack comprises:
locating, by the processor, one or more stack frames on the stack; and
locating, by the processor, a canary in the one or more stack frames based on a predefined stack frame format.

8. The method of claim 7, wherein locating a canary in the one or more stack frames based on the predefined stack frame format comprises:
locating, by the processor, a stack frame pointer in a stack frame; and
locating, by the processor, the canary in the stack frame at an offset relative to the stack frame pointer located in the stack frame, wherein the offset is predefined in the predefined stack frame format.

9. The method of claim 1, wherein locating the one or more canaries on the stack comprises:
locating, by the processor, one or more stack frames on the stack;
determining, by the processor, for each of the one or more stack frames whether the stack frame is associated with a no-return function attribute; and
locating, by the processor, a canary in the stack frame in response to determining that the stack frame is not associated with a no-return function attribute.

10. The method of claim 9, wherein locating the one or more canaries on the stack further comprises:
skipping, by the processor, the stack frame in response to determining that the stack frame is associated with a no-return function attribute.

11. A computing device, comprising:
a processor configured with processor-executable instructions to:
determine whether a condition for generating new canary values is satisfied;
generate one or more new canary values in response to determining that the condition for generating new canary values is satisfied;
locate one or more canaries on a stack; and
replace one or more previous canary values of the one or more canaries on the stack with the one or more new canary values.

12. The computing of claim 11, wherein the processor is further configured with processor-executable instructions to determine whether the condition for generating the new canary values is satisfied in response to forking a child process from a parent process in a memory, wherein the child process comprises the stack that includes the one or more canaries.

13. The computing device of claim 12, wherein the child process comprises a plurality of stacks to manage a plurality of processing threads, and wherein the processor is further configured with processor-executable instructions to:
generate a plurality of new canary values in response to determining that the condition is satisfied, wherein each of the plurality of new canary values corresponds to one of the plurality of processing threads;
locate the one or more canaries on each of the plurality of stacks; and
replace the one or more canaries on each of the plurality of stacks with the new canary values generated for the corresponding one of the plurality of processing threads.

14. The computing device of claim 11, wherein the processor is further configured with processor-executable instructions to:
determine whether the condition for generating the new canary values is satisfied by determining whether a child process was forked following a crash of one or more previous child processes; and
generate the one or more new canary values in response to determining that the condition for generating the new canary values is satisfied by generating the one or more new canary values in response to determining that the child process was forked following a crash of the one or more previous child processes.

15. The computing device of claim 11, wherein the processor is further configured with processor-executable instructions to:
determine whether the condition for generating the new canary values is satisfied by determining whether a canary timeout time has elapsed; and
generate the one or more new canary values in response to determining that the condition for generating the new canary values is satisfied by generating the one or more new canary values in response to determining that the canary timeout time has elapsed.

16. The computing device of claim 11, wherein to locate the one or more canaries on the stack the processor is further configured with processor-executable instructions to:
obtain a previous canary value;
locate one or more stack frames on the stack;
compare the previous canary value to data entries in the one or more stack frames; and
locate the one or more canaries on the stack at one or more locations corresponding to one or more of the data entries that match the previous canary value.

17. The computing device of claim 11, wherein to locate the one or more canaries on the stack the processor is further configured with processor-executable instructions to:
locate one or more stack frames on the stack; and
locate a canary in the one or more stack frames based on a predefined stack frame format.

18. The computing device of claim 17, wherein to locate a canary in the one or more stack frames based on the predefined stack frame format the processor is further configured with processor-executable instructions to:
locate a stack frame pointer in a stack frame; and
locate the canary in the stack frame at an offset relative to the stack frame pointer located in the stack frame, wherein the offset is predefined in the predefined stack frame format.

19. The computing device of claim 11, wherein to locate the one or more canaries on the stack the processor is further configured with processor-executable instructions to:
locate one or more stack frames on the stack;
determine for each of the one or more stack frames whether the stack frame is associated with a no-return function attribute; and
locate a canary in the stack frame in response to determining that the stack frame is not associated with a no-return function attribute.

20. The computing device of claim 19, wherein to locate the one or more canaries on the stack the processor is further configured with processor-executable instructions to:
skip the stack frame in response to determining that the stack frame is associated with a no-return function attribute.

21. A non-transitory processor-readable storage medium having stored thereon processor-executable instructions configured to cause a processor of a computing device to perform operations comprising:
determining whether a condition for generating new canary values is satisfied;
generating one or more new canary values in response to determining that the condition for generating new canary values is satisfied;
locating one or more canaries on a stack; and
replacing one or more previous canary values of the one or more canaries on the stack with the one or more new canary values.

22. The non-transitory processor-readable storage medium of claim 21, wherein the stored processor-executable instructions are configured to cause a processor of a computing device to perform operations such that determining whether the condition for generating the new canary values is satisfied is performed by the processor in response to forking a child process from a parent process in a memory, wherein the child process comprises the stack that includes the one or more canaries.

23. The non-transitory processor-readable storage medium of claim 22, wherein the child process comprises a plurality of stacks to manage a plurality of processing threads, and wherein the stored processor-executable instructions are configured to cause a processor of a computing device to perform further operations comprising:
generating a plurality of new canary values in response to determining that the condition is satisfied, wherein each of the plurality of new canary values corresponds to one of the plurality of processing threads;
locating the one or more canaries on each of the plurality of stacks; and
replacing the one or more canaries on each of the plurality of stacks with the new canary values generated for the corresponding one of the plurality of processing threads.

24. The non-transitory processor-readable storage medium of claim 21, wherein the stored processor-executable instructions are configured to cause a processor of a computing device to perform operations such that:
determining whether the condition for generating the new canary values is satisfied comprises determining whether a child process was forked following a crash of one or more previous child processes; and
generating the one or more new canary values in response to determining that the condition for generating the new canary values is satisfied comprises generating the one or more new canary values in response to determining that the child process was forked following a crash of the one or more previous child processes.

25. The non-transitory processor-readable storage medium of claim 21, wherein the stored processor-executable instructions are configured to cause a processor of a computing device to perform operations such that:
determining whether the condition for generating the new canary values is satisfied comprises determining whether a canary timeout time has elapsed; and
generating the one or more new canary values in response to determining that the condition for generating the new canary values is satisfied comprises generating the one or more new canary values in response to determining that the canary timeout time has elapsed.

26. The non-transitory processor-readable storage medium of claim 21, wherein the stored processor-executable instructions are configured to cause a processor of a computing device to perform operations such that locating the one or more canaries on the stack comprises:
obtaining a previous canary value;
locating one or more stack frames on the stack;
comparing the previous canary value to data entries in the one or more stack frames; and
locating the one or more canaries on the stack at one or more locations corresponding to one or more of the data entries that match the previous canary value.

27. The non-transitory processor-readable storage medium of claim 21, wherein the stored processor-executable instructions are configured to cause a processor of a computing device to perform operations such that locating the one or more canaries on the stack comprises:
locating one or more stack frames on the stack; and
locating a canary in the one or more stack frames based on a predefined stack frame format.

28. The non-transitory processor-readable storage medium of claim 27, wherein the stored processor-executable instructions are configured to cause a processor of a computing device to perform operations such that locating a canary in the one or more stack frames based on the predefined stack frame format comprises:
locating a stack frame pointer in a stack frame; and
locating the canary in the stack frame at an offset relative to the stack frame pointer located in the stack frame, wherein the offset is predefined in the predefined stack frame format.

29. The non-transitory processor-readable storage medium of claim 21, wherein the stored processor-executable instructions are configured to cause a processor of a computing device to perform operations such that locating the one or more canaries on the stack comprises:
locating one or more stack frames on the stack;
determining for each of the one or more stack frames whether the stack frame is associated with a no-return function attribute; and
locating a canary in the stack frame in response to determining that the stack frame is not associated with a no-return function attribute.

30. A computing device, comprising:
means for determining whether a condition for generating new canary values is satisfied;
means for generating one or more new canary values in response to determining that the condition for generating new canary values is satisfied;
means for locating one or more canaries on a stack; and
means for replacing one or more previous canary values of the one or more canaries on the stack with the one or more new canary values.
